(19) United States
(12) Patent Application Publication
(10) Pub. No.: US 2006/0178907 A1
(43) Pub. Date: Aug. 10, 2006

(54) Method and apparatus for on-demand directed diet advice

(76) Inventor: David R. Humble, Deerfield Beach, FL (US)

Correspondence Address: EDWARDS & ANGELL, LLP, P.O. BOX 55874, BOSTON, MA, 02205, US

(21) Appl. No.: 11/036,009

(22) Filed: Jan. 14, 2005

(51) Int. Cl. G06Q 10/00; G06Q 30/00

(52) U.S. Cl. 705/2; 705/26

(57) ABSTRACT

A system for providing on-demand directed diet advice is provided. A dieter computer communicates with a server. The server receives dieter characteristic data input at the dieter computer and stores the dieter characteristic data. The server also stores diet advice data files and associated data files characteristics. The categories of the data file characteristics substantially correspond to the categories of said dieter characteristics. The server compares the data files characteristics with the dieter characteristics in response to a request by the dieter at the dieter computer. The server transmits an advice data file to the dieter at the dieter computer when the data file matches at least one dieter characteristic.

### BACKGROUND OF THE INVENTION

This invention is directed to a method for dieting, and more particularly, a method and apparatus for providing expert advice on demand to a target audience as determined by the apparatus.

A majority of adults, at one time or another, adopt a diet or fitness plan to attain a desired weight or level of fitness or find themselves interested in health and fitness information (“dieters”). To accomplish this goal, people often seek the advice, coaching and help of a facilitator, particularly one who holds himself out as an expert.

The dieter may join a group such as the WEIGHT WATCHERS® diet program or the like to seek advice and motivation for maintaining the program. However, traditionally groups such as WEIGHT WATCHERS®, when providing “expert advice”, utilize facilitators at meetings at a predetermined location at predetermined times. A group of dieters who have adopted the WEIGHT WATCHERS® program will meet together to learn from the facilitator at the predetermined time and place.

This method of operation has been satisfactory. However, it suffers from the shortcomings that the preplanned meetings adopt a “one size fits all” philosophy. Because the presentations are limited in time and location, they appeal to the lowest common denominator of dieter and often ignore special needs dieters such as high cholesterol diets, diabetic diets, high blood pressure diets, low fat diets or the like. Furthermore, because a large number of presenters/facilitators are required to provide the numerous lectures demanded by the large number of dieters for the more national programs, the skill level is often non-uniform and many times advice is given by non-experts.

Lastly, because these presentations are at predetermined times and predetermined locations, it is often inconvenient for the dieter to attend. Therefore, the dieter may in fact miss the meeting. Furthermore, there is only a limited capacity to repeat the meeting by finding another time and location in which the exact same presentation will be provided by the same facilitator. Sometimes such a second meeting does not exist.

It is also known in the art to provide instruction by way of audio/visual aids such as CD ROMs, tapes, videotapes, DVDs or the like as well as to provide educational materials across the world wide web (“Internet”). All of these media have proven to be effective means of education which may be viewed at the convenience of the student. However, they suffer from the disadvantage that the user/student must determine which programs are available and which programs are most appropriate for the user based upon the limited description provided by the expert or media company.

Even with the advent of “magazines” provided over the Internet, on demand, the magazines, like the tapes or DVDs are designed to appeal to the interests of the lowest common denominator. Therefore, a person, such as a dieter who subscribes to a periodical over the Internet, as with prior art non-Internet articles, receives a periodical filled with information directed to the broadest audience, not specific interests. By way of example, the person interested in health and diet issues for diabetics may subscribe to a diabetic magazine, but get more than health and diet articles. On the other hand, if the person subscribes to a more general health and diet magazine, they will receive articles directed to a wide variety of health issues and be required to search out the specific information in which they are interested. Again, these prior art magazines suffer from the disadvantage that the user/dieter must determine which periodicals are available and which are most appropriate for them based upon a limited description provided about the magazine to which they subscribe. Accordingly, a method for providing expert advice to a dieter which will educate and motivate the dieter in accordance with the dieter's needs is desired.

Hand in hand with the issues and problems of directing information to users over the Internet is the issue of directing advertising information over the Internet. Initially, advertising was directed to users through the use of a banner space on a desired web page, much like a billboard on a desired real estate location. “Clicking” on the banner took the viewer to another location on the Internet where more information was offered. With the development of the Internet, it became more convenient to click on banners than other ways to move from site to site. The percent of viewers who utilized banners soared, and sites began to result in higher prices for the use of their banner space at their web site. This was a satisfactory business model, however, sites began to add more banners per page. Furthermore, end users became more familiar with the location of the sites of interest and therefore did not rely as heavily on banners to navigate the Internet. Lastly, major brands lured to the Internet as a branding medium found that the Internet was essentially a direct response medium and not a branding medium, such as television and print where the advertiser had command of the audience. As a result, there was a drop in the use of banners followed by the collapse of banner prices and collapse of the business model based upon banner advertising revenue.

Accordingly, it is desired to provide a method of directing advertiser-sponsored information to an end user in a manner that does not include the shortcomings of the banner method.

### BRIEF SUMMARY OF THE INVENTION

A server provides on-demand directed diet advice to a dieter over the Internet. Dieter characteristic data is stored in a database associated with the server. Advice data files and associated advice data characteristics are stored in the database. The categories of the advice data file characteristics substantially corresponding to the categories of the dieter characteristics. The server compares the advice data file characteristics to the dieter characteristics in response to a request from a dieter for advice. A selected at least one of said advice data files is transmitted to the dieter when at least one of the advice data file characteristics matches at least one of the dieter characteristics.

In one embodiment of the invention, the advice data is provided in the form of magazine articles. On a periodic basis, as new advice data files, in the form of magazine articles, are stored in the server, the server aggregates the articles corresponding to the dieter characteristic data and creates a magazine for the dieter as a function of the dieter characteristic data. The magazine may then either be requested by the dieter for transmission or on a periodic basis may be forwarded to the dieter at a dieter-convenient remote location. It should be noted, that non-dieter characteristic information may also be incorporated into the magazine to provide a general interest magazine in which the predominant articles are directed to the dieter.

In yet another embodiment of the invention, the dieter may be provided with a list of categories to prioritize in order of interest to the dieter. These categories correspond to the type of information embodied in the advice data. The priority of preferences within the categories of the advice data is stored as dieter characteristic data. The server utilizes the preferences, which can be changed by the user at any time, to select the magazine article embodiment of the advice data to form a virtual magazine and transmit the virtual magazine to the end user.

Advertising data and associated advertising data characteristics may be stored in the database. The categories of the advertising data correspond to the categories of the advice data file characteristics. The server, when aggregating the magazine, includes advertising data files having advertising data characteristics corresponding to the advice data characteristics of the selected advice data files forming the magazine.

### BRIEF DESCRIPTION OF THE DRAWINGS

FIG. 1 is a schematic diagram of a system for providing directed diet advice on demand in accordance with the invention;

FIG. 2 is a flowchart for a process of providing directed diet advice on demand in accordance with the invention;

FIG. 3 is a screen shot of a personalized virgual magazine in accordance with the invention; and

FIG. 4 is a screen shot of interior pages of a personalized magazine in accordance with the invention.

### DETAILED DESCRIPTION OF THE INVENTION

This invention provides for a system and method for providing on-demand directed diet advice. Applicant has noted that the use of an expert facilitator results in a dieter remaining on the diet program for a longer period of time. Therefore, to provide the correct diet advice upon demand, at the convenience of the dieter, lengthens the time which a dieter maintains the diet program even further.

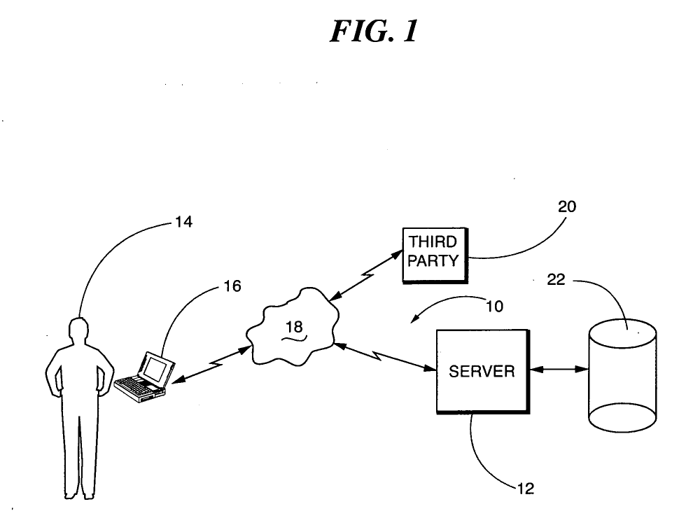

Reference is made to FIG. 1 in which a system, generally indicated as 10, is provided. System 10 includes a server 12 operatively communicating with a database 22. Server 12 communicates with users (“dieters”) 14 at a dieter computer 16 through Internet 18. Server 12 may also communicate with third party databases 20 through Internet 18.

In a preferred embodiment, server 12 provides an interactive web based portal such as a web page for interacting with dieter 14. It should be noted that computer 16 may be any interactive device which allows dieter 14 to communicate with server 12 and receive some type of text, audio, visual or audio/visual content at a dieter computer 16. It should be noted that the preferred embodiment is an Internet based system. However, the system may include any device capable of determining a dieter profile, selecting an expert for advice, and providing information from the expert to the dieter as will be described below. The computing device can communicate with a dieter 14 by Internet, radio frequency, telephone, cable TV, hand held personal data accessory (“PDA”) or cellular phone by way of non-limiting examples.

Database 22 stores dieter characteristic data about each dieter 14. Dieter characteristic data is in a preferred non-limiting example entered by dieter 14 utilizing computer 16. Dieter characteristic data may include any combination of a dieter's weight, height, age, dieting goal, dieting preferences and activity level. The dieting characteristic may also include the identity of a particular diet to which the dieter is adhering such as low carbohydrate, low fat, vegetarian or the like. Additionally, dieter characteristic data may include any medical condition such as prenatal, diabetic, high blood pressure, heart disease history, cancer or the like, or merely topics of interest to the dieter. The topics of interest are prioritized either by the dieter or in response to prompts from server 12.

Database 22 also stores a library of advice on a variety of topics from diet maintenance, tips for particular lifestyles such as high carbohydrate or low fat, exercise tips for various diets or medical conditions, and even nutritional information and tips for maintaining dieter 14 on a dieter selected diet. The advice may take the form of text files, audio files, audio/visual files or any combination thereof.

At a minimum, these files are expert files which mimic the type of information provided by the facilitator in the prior art, the difference being that the information is now provided uniformly by an expert and as will be shown below in an on-call manner. The advice may be on nutrition for a specific medical condition, diet tips, menu planning, exercise programs, or the like. It should be noted that the files may merely contain motivational advice for helping dieter 14 maintain on its diet.

Each advice file stored in server 12 also has characteristic information such as the nature of the advice given, motivational as opposed to exercise, as opposed to nutritional. The characteristic information may further be identified as relevant to specific medical conditions, specific diets, or just general advice. It should be noted that the different categories of characteristic data need not be mutually exclusive and in fact several categories can be used to describe a single type advice file or a dieter's needs. By way of example, a diabetic on a low carbohydrate diet could search for advice having either one of those characteristics (as they are both important), or both the characteristics to locate a single advice file. The advice characteristic information associated with each advice file is stored in database 22. The categories of diet characteristic data and advice characteristics generally correspond to each other.

Database 22 also stores a library of advertising corresponding to a variety of topics from diet aids, accessories for particular lifestyles, specific types of foods (high carbohydrate or low fat), drugs, medical devices, books on diet, exercising, medical conditions or cookbooks.

Each advertising file stored in server 12 also has characteristic information such as the nature of the information contained within the advertisement or the product or service itself, such as pharmaceuticals, diets or devices for a diabetic; food, cookbooks or other types of books for a low carbohydrate diet. Like the advice files, the characteristic information is identified as relevant to specific medical conditions, specific diets, or just general advice. Again, the different categories of characteristic data need not be mutually exclusive and in fact several categories can be used to describe a single advertising file. As discussed above, by way of example, a diabetic on a low carbohydrate diet would be the desired audience for advertisements for a cookbook. The advertising characteristic information associated with each advertising file is stored in database 22. The categories of the advertising characteristics data and the advice characteristics data generally correspond to each other.

Certain renowned experts may have pre-existing data files which are stored at database 22. Additionally, these facilitators may also have their own website acting as a data source for these data files at a third party data source 20. These websites would also have associated advice characteristics. Using the advice characteristics server 12 would locate the address of the appropriate advice and link computer 16 to the selected third-party database 20. The same is true of entities which sponsor or provide advertising.

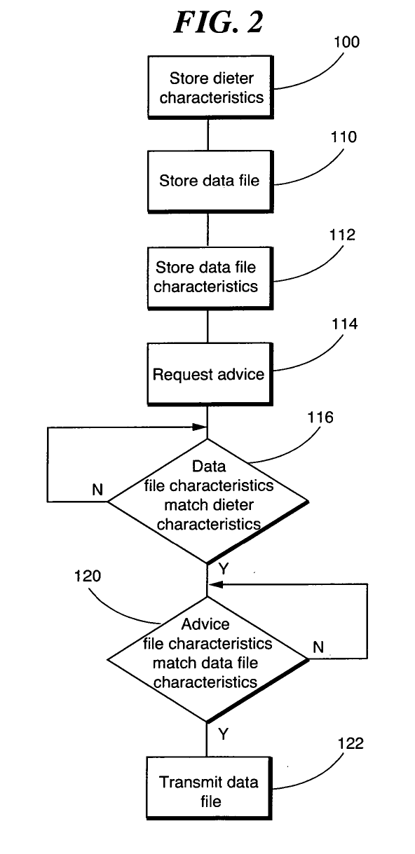

Reference is now made to FIG. 2 in which a method for providing targeted advice to a dieter is provided. As discussed above, in a step 100, dieter characteristic data is stored in database 22. This occurs by dieter 14 entering information about themselves at computer 16, and transmitting the data to server 12. Server 12 formats the dieter characteristic data and stores the data in database 22. As is known in the art, server 12, in the preferred embodiment, is a web portal for an online diet or diet information service.

In step 100, the characteristic data may only be limited to items of interest to the dieter, as the dieter need not necessarily be one on a diet, but any end user interested in specific information. Therefore, the characteristic data may merely be prioritized topics of interest. In another embodiment, it is contemplated that in step 100 server 12 may provide a list of topics of interest to dieter 14 for dieter 14 to prioritize and transmit as a prioritized list to server 12.

In a step 110, advice and informational data files are stored in database 22. These may be stored in a number of ways, including directly downloading at server 12 either by direct download or from a remote location such as third party database 20, through Internet 18. Additionally, it is contemplated that server 12 could merely store the uniform resource locator for advice found at third party database 20. It should be noted, that step 100 and 110 can be performed in reversed order without affecting the operation of the invention.

In a step 112, data file characteristics identifying the nature of the data file are stored in database 22. The category of data file characteristics, such as nutritional as opposed to medical, as opposed to motivational, and more specifically diabetic advice and cancer advice as opposed to low carbohydrate diet and low fat diet substantially correspond to the categories of characteristics of dieters 14 as a whole as stored in step 100.

In an optional embodiment, in steps 110 and 112, advertising data files are stored in server 12, either by direct download or from a remote location such as third party database 20. Advertising data file characteristics identifying the nature of the advertising are also stored in database 22. The category of advertising data file characteristics, such as nutritional as opposed to medical, as opposed to motivational, and more specifically, advertisements related to specific diseases as opposed to diet types substantially correspond to the categories and characteristics of the advice data file characteristics.

In a step 114, dieter 14 asks for a specific type of advice. Advice may be asked for in several ways which enable server 12 to target the correct advice in response to a specific request, a generic request from dieter 14 or no specific request at all.

In a first embodiment, as dieter 14 enters the web portal provided by server 12, dieter 14, by logging on, may cause server 12 to provide prompts at computer 16 for dieter 14. The prompts for advice may be determined, as will be discussed below, by comparing the dieter characteristic data with the advice data file characteristic data. By way of example, these prompts may be icons for a variety of types of advice such as menu suggestions, motivational tools to maintain the diet, physical activity to aid the dieting process of the particular dieter 14, or nutritional information. Dieter 14 if seeking advice during the web session merely selects the icon using a cursor as known in the art. Server 12 then causes the selected advice file to be downloaded or streamed to computer 16.

In a second embodiment, dieter 14 may specifically ask server 12 for advice information such as menu suggestions, health suggestions, exercise suggestions or motivational advice. This can be done through a help key or any search engine data input tool as currently known in the art. Server 12, in accordance with the rules discussed below, would then provide the appropriate data file from database 22 at computer 16.

In a third embodiment, server 12 is an on-line diet service as is known in the art, such as the menu plans provided by eDiets.com, by way of example. In such a system server 12 is web portal which provides suggested menus to dieter 14 along with diet advice and the like. The menus are created as a function of the type of diet dieter 14 elects to follow. The menu can be determined by utilizing dieter characteristic data.

In this embodiment server 12 may monitor how often dieter 14 accesses server 12. This can be counted in time intervals such as days, weeks or months or by the number of times server 12 has been accessed (“hits”). Each predetermined period, server 12 can select appropriate diet advice as a function of dieter characteristic data, and transmit such diet advice or hot link information for third party data 20 to computer 16. By way of example, every two weeks server may forward appropriate menu advice to provide dieter 14 with a continuous variety of foods, or every week, server 12 may forward appropriate medical advice if a medical condition such as diabetes is indicated by the dieter characteristic data. Similarly, every tenth “hit” by dieter 14, server 12 may provide menu advice to dieter 14.

In yet another embodiment, server 12 can use either the failure of dieter 14 to access server 12, or ongoing permission to send new information to dieter 14 as a request. For example, if dieter 14 falls off the diet and does not access server 12 for a predetermined period such as two weeks, server 12, which tracks user access as known in the art, will determine that two weeks have passed and will e-mail either motivational advice or menu advice to dieter 14 at computer 16. Or, if a standing request exists, as new data files are loaded, if the data file characteristic matches the dieter characteristic as determined in step 116, server 12 could e-mail the new data file to user 14 at computer 16.

In any of the embodiments, server 12 would then either automatically cause the advice to be presented at computer 16 or provide a hot link at computer 16 to allow dieter 14 the option of requesting that specific advice from server 12 or third party source 20.

Once the advice is requested, in a step 116, server 12 compares the advice data file characteristic data with the dieter characteristic data to determine whether or not there is a match between the dieter-specific dieter characteristic data and a data file characteristic. If there is not, step 116 is repeated until a match is found.

If there is a match, then the matching data file is transmitted to computer 16 by server 12 over the Internet in a step 118. In an alternative embodiment, server 12 may merely provide a hot link address to third party database 20.

In one preferred embodiment, the data is text files in the form of magazine articles about the advice data. Where the request is a preauthorized periodic request, on a periodic basis, all articles corresponding to the dieter characteristic data are aggregated and in a preferred embodiment may be formatted as a virtual magazine having a cover page and articles printed on pages which may be virtually turned at computer 16. The characteristic-specific advice would then be transmitted to the dieter.

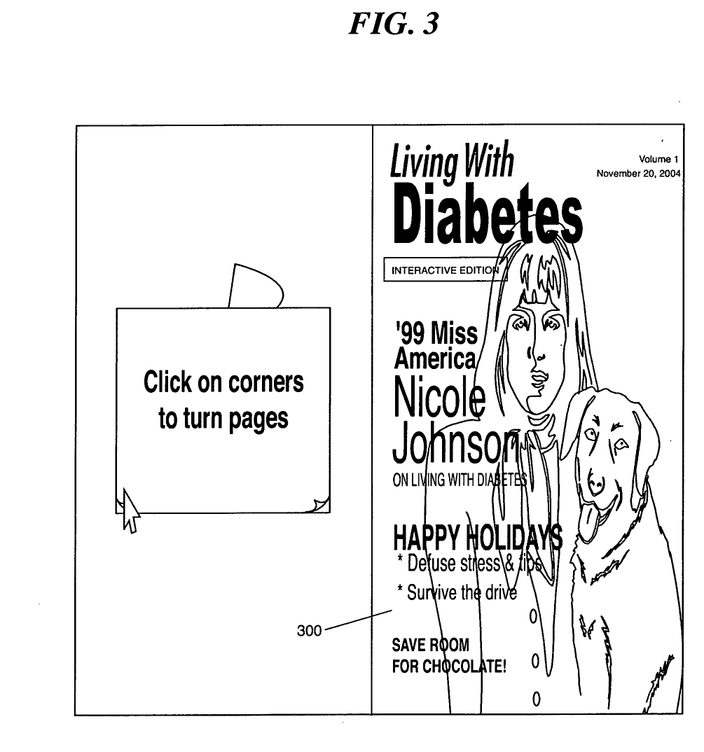

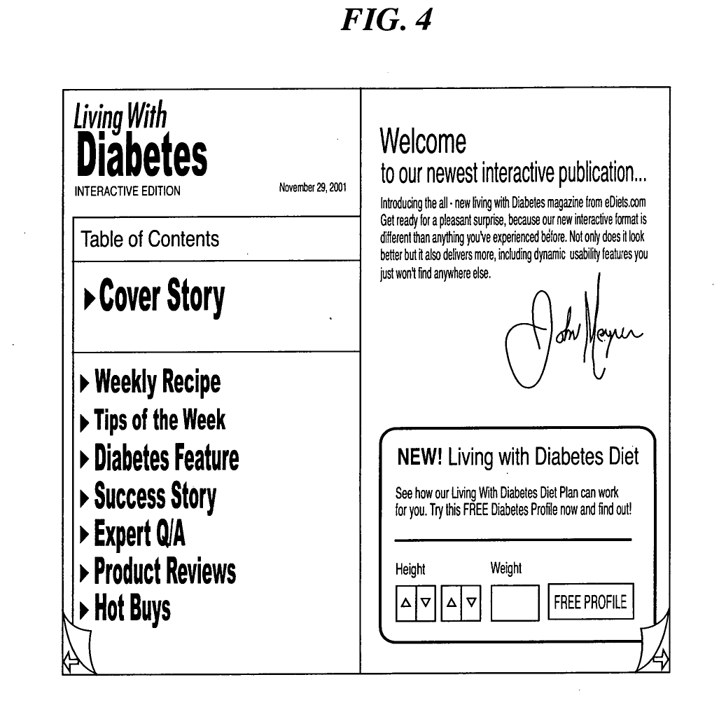

The advice would appear at computer 16 as a virtual magazine with cover 300 as shown, by way of example in FIG. 3. The virtual magazine, in this example, is directed to a user/dieter having advice data corresponding to diabetes advice transmitted in response to dieter characteristic data. As is known in the art, the virtual magazine may turn virtual pages 302, 304 as shown in FIG. 4 having normal pages and a table of contents. Articles would appear on these pages. The positioning of the articles would be a function of the priority preferences of dieter 14 as input as part of the dieter characteristic data in step 110. In other words, as a function of the priorities stored as dieter characteristic data, server 12 formats advice as a personalized virtual magazine. Dieter 14 then turns the pages of the virtual magazine as known in the art.

Additional articles, not dieter characteristic related, but of general interest may also be included in the aggregation, but the dieter characteristic advice would be provided a prominent position within the magazine. It should be noted, that for this embodiment, a dieter need not necessarily be a person interested in dieting or pursuing a diet, but may merely have interests corresponding to the advice characteristic data.

In the same manner, advertising data files may be aggregated as part of the virtual magazine and inserted with the articles by placing the advertisement within articles by comparing the advertising characteristic data with the advice characteristic data in an optional step 120. If the advertising characteristic data matches the advice characteristic data, the corresponding advertising data file is aggregated with the corresponding advice data file article. A virtual page of the magazine in proximity to the article will have the selected advertising.

By providing a server accessible over the Internet which can match dieter characteristic data to specific advice and transmit that information back to dieter 14 at any location at which a computer 16 is provided, uniform targeted subject-appropriate advice can be provided to dieter 14 at the convenience of dieter 14.

As a result of providing a vehicle in which an advertiser may insert advertising in a personalized online magazine by linking their advertisement to a specific category, the advertisement will now be prominently placed in a magazine in proximity of viewers of interest. Furthermore, because of the virtual magazine format, the advertisement will be placed above the fold where each ad must be seen while providing the opportunity to command full attention of the viewer to deliver a complete marketing message which, as a result of the linking aspects of the Internet, may be relatively infinitely long.

Thus, while there have been shown, described and pointed out novel features of the present invention as applied to preferred embodiments thereof, it will be understood that various omissions and substitutions and change in the form and detail are contemplated so that the disclosed invention may be made by those skilled in the art without departing from the spirit and scope of the invention. It is the intention, therefore, to be limited only as indicated by the scope of the claims appended hereto. It is also to be understood that the following claims are intended to cover all of the generic and specific features of the invention herein described and all statements of the scope of the invention, which, as a matter of language, might be said to fall therebetween.

What is claimed as new and desired to be protected by Letters Patent of the United States is:

1. A method for providing on-demand directed diet advice comprising the steps of:
storing dieter characteristic data;
storing data files and associated data file characteristics, categories of said data file characteristics substantially corresponding to categories of said dieter characteristic data;
comparing said data file characteristics to said dieter characteristic data in response to a request from a dieter for advice; and
transmitting a selected at least one of said data files to said dieter when at least one of said data file characteristic matches at least one of said dieter characteristic data.

2. The method of claim 1, wherein said data file is an audio/visual file capable of being opened at a dieter computer.

3. The method of claim 1, wherein said data file is a text file.

4. The method of claim 3, further comprising the steps of formatting said text file as an article in a magazine, said article having at least one page, the pages being capable being turned at a dieter computer.

5. The method of claim 1, further comprising the steps of storing advertising data files and associated advertising data file characteristics, categories of said data file characteristics substantially corresponding to categories of said data file characteristics; comparing said data file characteristics to said advertising data file characteristics in response to a request from a dieter for advice; formatting said data file being a text file, and; formatting said text file as an article in a virtual magazine, said article having at least one page, and said advertising data file being positioned in said virtual magazine at a page in proximity to said article.

6. The method of claim 1, wherein said request is a request by said dieter in response to a prompt provided at a dieter computer.

7. The method of claim 1, wherein said request is a request transmitted by said dieter across the Internet to a server, said server being associated with a database, said data file and dieter characteristic data being stored at said database.

8. The method of claim 1, wherein a server provides online dieting services across the Internet, said server monitors access to said server by said dieter and at predetermined intervals transmits said selected data file to said dieter across the Internet.

9. The method of claim 8, wherein said online dieting services is the provision of information to a dieter, said data file being a text data file, and further comprising the method of aggregating at least one of said selected at least one of said advice data file to form an aggregation of data files, and formatting said aggregation of data files as a virtual magazine having pages, a respective one of each of said data files forming an article in said virtual magazinemagazine, said article being formatted as a series of said pages capable of being turned by said dieter.

10. The method of claim 9, wherein said advertising data file and data file are text files, and further comprising the steps of storing advertising data files and associated advertising data file characteristics, categories of said advertising data file characteristics substantially corresponding to categories of said data file characteristics; comparing said data file characteristics to said advertising data file characteristics in response to a request from a dieter for advice, and formatting said data file as an article in a virtual magazine, said article having at least one page, and said advertising data file being positioned in said virtual magazine at a page in proximity to said article.

11. A system for providing on-demand directed diet advice comprising:
a dieter computer;
a server in communication with said dieter computer, said server receiving dieter characteristic data input at said dieter computer and storing said dieter characteristic data, said server storing diet advice data files and associated data file characteristics, categories of said advice data file characteristics substantially corresponding to said dieter characteristics;
said server comparing said data file characteristics with said dieter characteristics in response to a request by said dieter at said dieter computer and transmitting an advice data file to said dieter at said dieter computer when one of said data file characteristics matches at least one dieter characteristic.

12. The system of claim 11, wherein said data file is an audio/visual file capable of being opened at said dieter computer.

13. The system of claim 11, wherein said data file is a text file.

14. The system of claim 11, wherein the said text file is an aritcle in a virtual magazine, said virtual magazine having pages, said article having at least one said page, the pages being capable being turned at a dieter computer.

15. The system of claim 11, wherein said advertising data file and data file are text files and said server stores advertising data files and associated advertising data file characteristics, categories of said data file characteristics substantially corresponding to categories of said data file characteristics and compares said data file characteristics to said advertising data file characteristics in response to a request from a dieter for advice; said server formatting said data file as an article in a virtual magazine, said article having at least one page, and said advertising data file being positioned in said virtual magazine at a page in proximity to said article.

16. The system of claim 11, wherein said request is a request by said dieter in response to a prompt provided at said dieter computer.

17. The system of claim 11, wherein said request is a request transmitted by said dieter across the Internet to said server, said server being associated with a database, said data file and dieter characteristic data being stored at said database.

18. The system of claim 11, wherein said server provides dieting services across the Internet, said server monitors access to said server by said dieter and at predetermined intervals transmits said selected data file to said dieter across the Internet.

19. The system of claim 18, wherein said online dieting services is the provision of information to a dieter, said data file being a text data file, said server aggregating at least one of said selected at least one of said diet data files to form an aggregation of data files, and formatting said aggregation of data files as a virtual magazine, a respective one of each of said data files forming an article in said magazine, said article being formatted as a series of pages, capable of being turned by said dieter.
